(19) United States
(12) Patent Application Publication
(10) Pub. No.: US 2003/0221066 A1
(43) Pub. Date: Nov. 27, 2003

(54) Memory card and memory card data recording method

(76) Inventor: Yoshio Kaneko, Chiba-ken (JP)

Correspondence Address: Finnegan, Henderson, Farabow,, Garrett & Dunner, L.L.P., 1300 I Street, N.W., Washington, DC, 20005-3315, US

(21) Appl. No.: 10/395,219

(22) Filed: Mar. 25, 2003

(30) Foreign Application Priority Data
Mar. 26, 2002 (JP) 2002-084930

(51) Int. Cl. G06F 12/14; G06F 12/16

(52) U.S. Cl. 711/115; 711/162; 711/164

(57) ABSTRACT

Memory cards allow multiple connections to applicable devices. In one example, a memory card can make simultaneous connections to multiple devices and record and playback data content from the multiple devices. In another example, the memory card can connect to different devices at different times in order to record different data content into the memory card. In still other examples, a first memory card can be connected and used by a first device and a second memory card can connect to a second device to record data content from the second device. The second card can then be connected to the first memory card to introduce the data content from the second device into the first memory card.

### CROSS-REFERENCE TO RELATED APPLICATIONS

This application claims the benefit of priority from prior Japanese Patent Application No. P2002-84930 filed Mar. 26, 2002, the contents of which are incorporated herein by reference.

### FIELD OF THE INVENTION

The present invention relates generally to memory cards and, more particularly, to a memory card and memory card data recording method.

### BACKGROUND OF THE INVENTION

One type of memory card is a secure digital (SD) memory card. This type of card provides secure access to data stored within the SD memory card. FIG. 1 illustrates a conventional SD card memory 50 (“SD card 50”).

Referring to FIG. 1, SD card 50 includes a group of input/output (I/O) terminal I/O ports 51 (“I/O terminals 51”). I/O terminals 51 are located on the left-side section of the outer periphery of the SD card 50. I/O terminals 51 include power signal terminals, clock signal terminals, data signal terminals, command signal terminals, etc. Although not shown, an applicable device can connect with SD card 50 via I/O terminals 51. Suitable devices that can connect with SD card 50 include a SD card playback device or a SD card download device.

SD card 50 also includes an interface controller 53 coupled to I/O terminals 51, memory core interface 54, and serial number holding circuit 55. Interface controller 53 processes signals to and from those components and includes control circuitry such as a central processing unit (CPU) to process such signals. Memory core interface 54 is coupled to a memory core 52 that controls data transfer to and from memory core 52. Examples of memory core 52 include a flash memory for storing downloaded data from a connected device to SD card 50.

Interface controller 53 controls serial number holding circuit 55 to perform security functions for SD card 50. For instance, serial number holding circuit 55 stores a code key (e.g., serial number) that is used to determine if a connected device to SD card 50 can access data or store data in memory core 52. In particular, when a connected device requests playback of data in memory core 52, the device sends interface controller 53 a code key, which is confirmed with a code key in serial number holding circuit 55. If the code key is confirmed, interface controller 53 allows the connected device to receive data from memory core 52.

When data is written in memory core 52 from a connected device, serial number holding circuit 55 sends the connected device a code key (e.g., serial number) unique to SD card 50 via interface controller 53 and I/O terminals 51. Serial number holding circuit 55 stores the code key that is allotted for each SD card. The connected device, after receiving the code key, outputs coded data to SD card 50 in a format unique to the code key, e.g., corresponding to the serial number of SD card 50. SD card 50 then processes the coded data in the serial number holding circuit 53 in which the coded data is multiplexed using an independent decoding key, e.g., corresponding to the serial number of SD card 50. The multiplexed data is then recorded or stored in memory core 52. In this manner, security can be maintained for accessing or recording data in SD card 50.

Depending on the type of memory core interface 54, memory core interface 54 writes in or reads out data to and from memory core 52, or erases data in memory core 52. Furthermore, if a request is made to playback data from memory core 52, memory core interface 54 can provide coded data output from memory core 52. In particular, memory core interface 54 can process data from memory core 52 in a coded format. SD card 50 is also provided with a cutaway 56 in a single location at the end of the SD card 50. The location of cutaway 56 is at the same end of SD card 50 as I/O terminals 51. In this manner, a user can easily identify the end with I/O terminals 51 to connect to an applicable device. Furthermore, this allows the user to connect the device to SD card 50 in a correct I/O terminal position.

Further details of security functions for conventional SD cards will now be explained. In order to perform security functions, conventional SD cards (or memory cards) contain coded data and a deciphering code key to decipher the coded data. If a connected device uses the proper deciphering code key, it can decipher or decode the coded data from the SD card and playback the original data content in the SD card. For instance, based on the characteristic serial number of the SD card, a deciphering code key that matches the serial number is transmitted to the connected device for deciphering the coded data in the SD card. Thus, even if the coded data and deciphering code key are copied into another SD card, without the proper serial number of the original SD card, the proper deciphering code key cannot be determined. In this case, if the deciphering code key cannot be used, it can be determined that the code key has been copied and playback of data content is not possible without using the original SD card. This ensures that only the original SD card can be used to playback data originally stored in the SD card. External devices that connect to the SD cards receive the code key (e.g., serial number), coded content, and data for deciphering the code key from the SD cards to implement the security functions. With such security functions, conventional SD cards can prevent illegal or unauthorized copying of data content.

Furthermore, to copy data content from one conventional memory card to another conventional memory card, both memory cards are inserted into a memory card copying device (i.e., a data exchanger) that performs the copying. The data exchanger receives the code key (serial number) and deciphering key data from a source memory card, and checks for a deciphering method. After checking for a deciphering method, the data exchanger creates a deciphering code key corresponding to the source memory card serial number and provides the deciphering code key to the recipient memory card. The data exchanger can also copy coded content to the recipient memory card. Lastly, the data exchanger passes a copying-complete status indication to the source memory card such that overwriting is preserved, and data content can no longer be played back in the source memory card. Two personal computers can also be configured with copying devices and connected by way of a Local Area Network (LAN) or the Internet as data exchangers.

The above security schemes require sending a deciphering code key in a memory card to a connected device to decode coded content in the memory card. In particular, the memory card sends coded content to the connected device that uses the deciphering code key to playback content in the memory card. In this manner, coded content in the memory card can be decoded and converted by the connected device into content such as music, game software, book data, etc. that can be enjoyed by users of the connected device.

However, there are a number of drawbacks and disadvantages with using conventional SD memory cards as discussed above. In conventional SD memory cards, only one group of I/O terminals is provided per memory card in accordance with standard specifications. Thus, the memory card memory can only communicate with one device at a time. Because there is only one group of I/O terminals for a memory card to connect to a device, to introduce different content, the user of the device would have to abort use of current data content in the memory card. For example, a user would have to abort current playback of music or video data content in the memory card to introduce new and different data content.

Furthermore, if a conventional SD card is being used by a device such as a computer or television to playback content in the SD card and a user wants to introduce new or different content into the SD card, the user would have to remove the SD and connect to a different device to introduce the new and different content into the SD card. This requires interrupting the user's current enjoyment of playing back data content in the device. More particularly, if an SD card is required to watch a specific program on a pay-for-view broadcast and the user wants to watch a different program that requires a different memory card, the user has to remove the original SD card and connect the different SD to the television. This requires two separate SD cards because the code key in the original SD card cannot be used to watch the different program that requires a different SD card. In addition, in order copy data between two SD cards, a data converter is needed to copy data from one SD card to another SD card.

### SUMMARY OF THE INVENTION

Memory cards are disclosed that overcome the disadvantages of conventional memory cards.

According to one aspect of the invention, a memory card is disclosed having first input/output (I/O) terminals, a first interface controller, second input/output (I/O) terminals, a second interface controller, at least one memory core, and a memory core interface controller. The first I/O terminals have at least one terminal for inputting and outputting first data. The first interface controller controls the first data to and from the first I/O terminals. The second I/O terminals having at least one terminal for inputting and outputting second data, and wherein the first data is different from the second data. The second interface controller controls the second data to and from the second I/O terminals. The memory core interface controller controls retrieving or storing of at least one of the first data and second data in the memory core.

According to another aspect of the invention, a memory card is disclosed having first input/output (I/O) terminals, a first interface controller, first connector terminals, at least one memory core, and a memory core interface controller. The first I/O terminals have at least one terminal for inputting and outputting first data. The first interface controller controls the first data to and from the first I/O terminals. The first connector terminals are capable of connecting the memory card to a different memory card. The memory core interface controller controls retrieving or storing of at least the first data in the memory core.

According to another aspect of the invention, a memory card is disclosed having first and second memory cards and a connector. Each memory card includes at least one memory core to store data content and is capable of connecting to separate devices and to each other. The connector is capable of connecting the first memory card with the second memory card such that data content is capable of being transferred directly between the first and second memory cards.

According to a further aspect of the invention, there is provided a data recording method for a memory card. First data is recorded in a memory core of the memory card via first input/output (I/O) terminals. Second data is recorded in the memory core of the memory card via second input/output (I/O) terminals, wherein the first I/O terminals and the second I/O terminals are respectively located at opposite ends of the memory card.

According to yet another aspect of the invention, there is provided a method of recording data into a memory card having a first memory card and a second memory card interconnected by a connector. First data is recorded into the first memory card. The first data is read from the fist memory card by a first device. The second memory card is detached from the connector. Second data is recorded into the second memory card from a second device. The second memory card is reattached to the connector. The second data from the second memory card is copied into the first memory card.

Other features and advantages will be apparent from the accompanying drawings, and from the detailed description, which follows below.

### BRIEF DESCRIPTION OF THE DRAWINGS

The accompanying drawings, which are incorporated in, and constitute a part of this specification illustrate exemplary embodiments and implementations and, together with the description, serve to explain the principles of the invention. In the drawings,

FIG. 1 illustrates a block diagram of a conventional memory card;

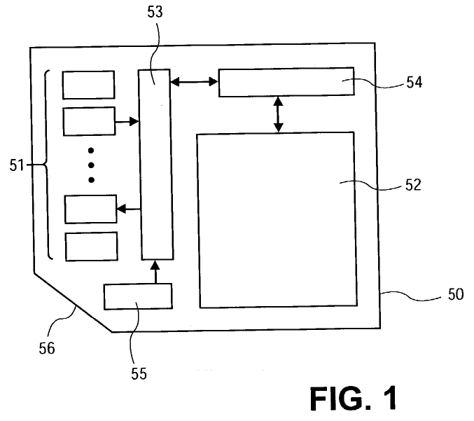

FIG. 2 illustrates a block diagram of one embodiment of a memory card consistent with the invention;

FIG. 3 illustrates a block diagram of another embodiment of a memory card consistent with the invention; and

FIG. 4 illustrates a perspective view of the memory card of FIG. 3 consistent with the invention.

### DETAILED DESCRIPTION

Reference will now be made in detail to embodiments and implementations, examples of which are illustrated in the accompanying drawings. Wherever possible, the same reference numbers will be used throughout the drawings to refer to the same or like parts.

Memory cards are disclosed that overcome the disadvantages of conventional memory cards and allow multiple connections to applicable devices. In one example, a memory card can make simultaneous connections to multiple devices and record and playback data content from the multiple devices. In another example, the memory card can connect to different devices at different times in order to record different data content into the memory card. In still other examples, a first memory card can be connected and used by a first device and a second memory card can connect to a second device to record data content from the second device. The second card can then be connected to the first memory card to introduce the data content from the second device into the first memory card.

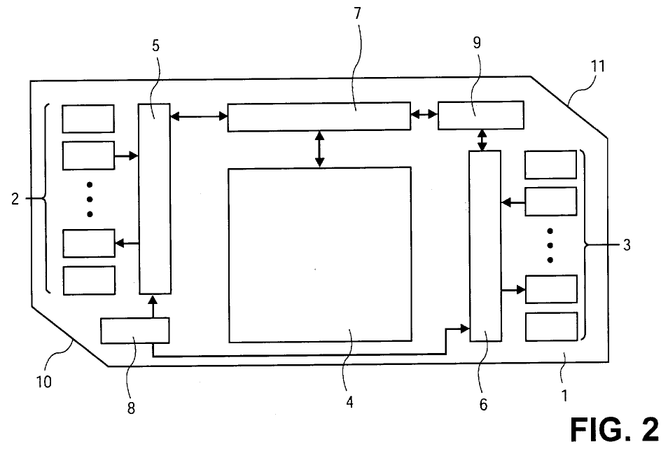

FIG. 2 illustrates a block diagram of one embodiment of an SD memory card 1 (“SD card 1”) consistent with the invention. SD card 1 includes first and second input/output (I/O) terminals 2 and 3, first and second interface controllers 5 and 6, a memory core 4, a memory core interface 7, a serial number holding circuit 8, and a serial voltage conversion circuit 9. SD card 1 is also provided with a first cutaway 10 and a second cutaway 11.

First I/O terminals 2 are located at one peripheral end (left end) of SD card 1 and second I/O terminals 3 are located at a second peripheral end (right end) of SD card 1. Both first and second I/O terminals 2 and 3 have a plurality of terminals including power signal terminals, clock signal terminals, data signal terminals, command signal terminals, etc. First I/O terminals 2 and second I/O terminals 3 can have the same type and number of terminals to perform similar functions. Alternatively, first and second I/O terminals 2 and 3 can have different types of terminals for different types of devices. As such, first and second I/O terminals 2 and 3 may couple different devices to SD card 1. For example, first I/O terminals 2 may coupled SD card 1 to an SD card playback device (e.g., an MPEG payer) and second I/O terminals 3 may couple SD card 1 to a download device (e.g., a hand-held computing device).

Memory core 4 is a data content storage device such as a flash memory. Memory core interface 7 is coupled to memory core 4 and allows a connected device to SD card 1 to store (record) and retrieve (playback) data content in memory core 4. In particular, memory core interface 7 stores/writes in, retrieves/reads out, or even erases data content in memory core 4. Thus, during playback of data content, the data content from memory core 4 is sent to memory core interface 7. Storage capacity for memory core 4 can be, e.g., 64 Mbyte, 128 Mbyte, 256 Mbyte, etc.

First and second interface controllers 5 and 6 and are coupled to first and second I/O terminals 2 and 3, respectively, and control and process signals to and from first and second I/O terminals 2 and 3. First and second interface controller 5 and 6 are also coupled to memory core interface 9. Interface controllers 5 and 6 each include control circuitry such as a central processing unit (CPU) to control and process such signals.

Serial number holding circuit 8 performs security functions for SD card 1, and is controlled by first and second interface controllers 5 and 6. For instance, if a device connected to SD card 1 requests playback of data content in memory core 4, the device sends a code key (e.g., serial number) to either first or second controllers 5 and 6 (depending on the I/O terminal connection). Interface controllers 5 or 6 will confirm the serial number with a serial number for SD card 1 in serial number holding circuit 8. If the serial number is confirmed, interface controllers 5 or 6 will allow the connected device to playback data content in memory core 4.

To store or record data content by the connected device, serial number holding circuit 8 sends the connected device a code key or serial number unique to SD card 1 by way of the first interface controller 5 and first I/O terminals 2 or by way of the second interface controller 6 and second I/O terminals 3. After receiving the code key or serial number, the connected device outputs data to SD card 1 in a coded format that corresponds to the serial number of SD card 1. SD card 1 can then record the coded data in memory core 4. In this manner, while maintaining data security, data content from the connected device can be stored in SD card 1.

The signal voltage conversion circuit 9 is coupled between the second interface controller 6 and the memory core interface 7 to protect SD card 1 from damaging voltage fluctuations. For instance, if SD card 1 is simultaneously connected to two applicable devices, a difference in voltage potential of at least 1V can be expected between the pair of applicable devices. This voltage potential difference can last for several minutes and cause damage to SD card 1. Therefore, SD card 1 is provided with signal voltage conversion circuit 9 to adjust for any voltage potential differences between the connected devices such that an equal voltage potential is established. This prevents operation of SD card 1 from becoming unstable. Moreover, SD card 1 can use a voltage level such as 3V for connecting the devices. Thus, SD card 1 can mutually separate power distribution among first I/O terminals 2 and first interface controller 5 and second I/O terminals 6 and second interface controller 6.

Cutaways 10 and 11 are provided at opposite ends of SD card 1. In particular, cutaway 10 is located at a lower left end of SD card 1, which is at the same end as first I/O terminals 2. Cutaway 11 is located at an upper right end of SD card 1, which is at the same end as second I/O terminals 2. Cutaways 10 and 11 allow a user to identify the first and second I/O terminals 2 and 3 such that the user can correctly connect applicable devices to SD card 1 via first and second I/O terminals 2 and 3. In this example, cutaways 10 and 11 are located at opposite ends of SD card 1 in which cutaway 10 is located at a lower position and cutaway 11 is located at an upper position. By locating cutaways 10 and 11 in such a way, first and second I/O terminals 2 and 3 can be differentiated by a user.

Furthermore, to implement security functions for SD card 1, memory core 4 may include a data protection area and a user data area. The data protection area can store one or more keys (e.g., encryption and decryption keys) and other secured data. This area of memory core 4 can be configured to be accessible in a secured and controlled manner using a verification process. For instance, memory core 4 can be configured to allow a system access to the data protection area after a mutual verification process using the serial number of SD card 1. The user data area can store normal, accessible user data.

One example of using both the data protection area and the user data area for downloading/recording data content in SD card 1 is as follows. If music data content is downloaded into SD card 1, the data content can be recorded in the user data area after it has been coded (encrypted) with a code key and other control information stored in the data protection area, which is only accessible based on a verification process. Thus, the information stored in the data protection area can be copied only by a legitimate and mutually verifiable process. In addition, to playback or retrieve data content from memory core 4, the code key used to code data content can be retrieved from the data protection area, and the retrieved code key can be used to decode coded content by a connected device.

SD card 1 can thus make two connections at opposite ends of SD card 1. However, in this example, SD card 1 has a vertical length (in the inserted position) that is longer than a conventional SD card to avoid a simultaneous connection at both ends of SD card 1 with the same device. For instance, if a device is connected to SD card 1 at first I/O terminals 2, the vertical length of SD card 1 is of such a length that it can avert an unintentional contact or connection with the same device at second I/O terminals 3.

With the SD card 1, as shown in FIG. 2, first I/O terminals 2 and first interface controller 5 are independent from second I/O terminals 3 and second interface controller 6. Data in memory core 4 can thus be read out independently to applicable devices connected to first and second I/O terminals 2 and 3. In this manner, a user of SD card 1 can enjoy recording of data content in SD card 1 from a device connected to first I/O terminals 2 and downloading of data content into SD card 1 from a different device connected to second I/O terminals 3. SD card 1 discussed above can be configured to be super-small, lightweight, and highly durable. SD card 1 can also have simple and high-speed interfaces and implement broad applications with copy protection functions.

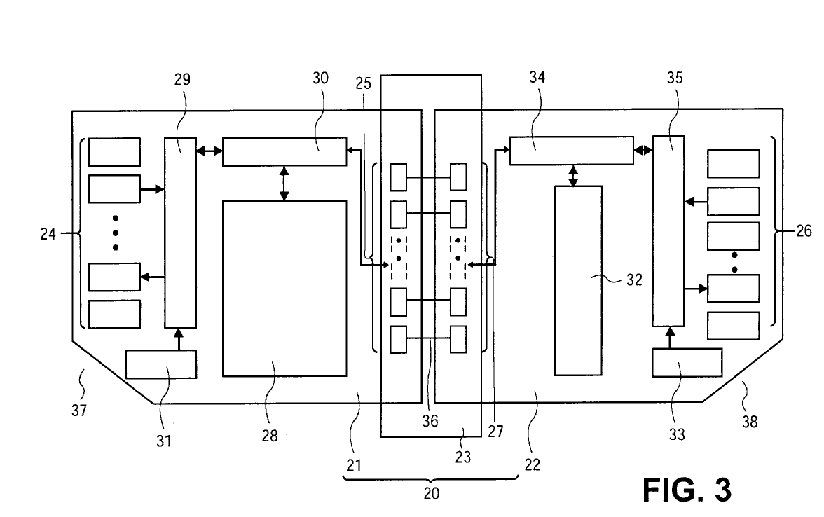

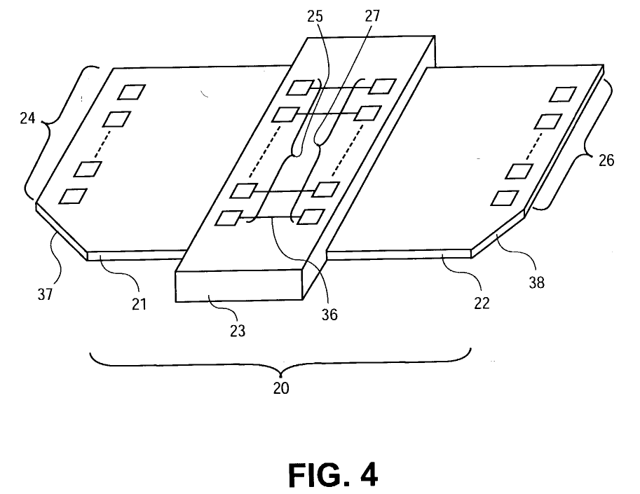

FIGS. 3 and 4 illustrate another embodiment of an SD memory card 38 (“SD card 38”) consistent with the invention. Referring to FIGS. 3 and 4, SD card 38 includes a first memory card 21 and a second memory card 22 that are interconnected by a connector 23.

First memory card 21 includes a first input/output (I/O) terminal group 24 (“first I/O terminals 24”) located on the left side of first memory card 21 and a first group of connector terminals 25 (“first connector terminals 25”) located on the right side of first memory card 21. Second memory card 22 includes a second group of connector terminals 27 (“second connector terminals 27”) to connect to first memory card 21 via connector 23. Second connector terminals 27 are located on the left side of second memory card 22. Memory card 22 also includes a second input/output (I/O) terminal group 26 (“second I/O terminals 26”) located on the right side of second memory card 22.

First and second I/O terminals 24 and 26 and first and second connector terminals 25 and 27 for first and second memory cards 21 and 22, respectively, include power terminals, clock terminals, data terminals, command terminals, etc. In one example, first and second I/O terminals 24 and 26, as well as first and second connector terminals 25 and 27, are configured in the same manner having identical structure, functions, and number of terminals. In another example, first and second I/O terminals 24 and 26, as well as first and second connector terminals 25 and 27, can be configured in a different manner having different structure, functions, and number of terminals. First and second I/O terminals 24 and 26 can thus be coupled to different applicable devices.

First memory card 21 includes a first memory core 28 and a first memory core interface 30. First memory core 28 is a data storage component such as a flash memory to store downloaded data content. First memory core interface 30 is coupled to first memory core 28 and allows a device connected to first memory card 21 to store (record) and retrieve (playback) data content in first memory core 28. In particular, first memory core interface 30 stores/writes in, retrieves/reads out, or even erases data content in first memory core 28. Thus, during playback of data content, the data content from first memory core 28 is sent to first memory core interface 30. Storage capacity for first memory core 28 can be, e.g., 64 Mbyte, 128 Mbyte, 256 Mbyte, etc.

First memory card 21 also includes a first interface controller 29 and a first serial number holding circuit 31. First interface controller 29 is coupled to first I/O terminals 24 and control and process signals to and from first I/O terminals 24. First interface controller 29 is also coupled to memory core interface 30. First interface controller 39 includes control circuitry such as a central processing unit (CPU) to control and process signals.

First serial number holding circuit 31 performs security functions for first memory card 21, and is controlled by first interface controller 29. In one example, if a connected device to SD card 21 requests playback of data content in memory core 28, the device sends a code key (i.e., serial number) to first interface controller 29. First interface controller 29 will confirm the serial number with a serial number for SD card 21 in first serial number holding circuit 31. If the serial number is confirmed, first interface controller 29 will allow the connected device to playback data content in memory core 28 in first memory card 21.

In another example, for the connected device, to store or record data content in first memory card 21, first serial number holding circuit 31 sends the connected device a code key or serial number unique to first memory card 31 by way of the first interface controller 39 and first I/O terminals 29. After receiving the code key or serial number, the connected device outputs data to first memory card 21 in a coded format that corresponds to the serial number of first memory card 21. First memory card 21 can then record the coded data in memory core 28. In this manner, while maintaining data security, data content from the connected device can be stored in first memory card 21.

Second memory card 22 can be configured in a similar manner as first memory card 21. In particular, second memory card 22 includes a second memory core 32 and a second memory core interface 34. Second memory core 32 is a data storage component such as a flash memory to store downloaded data content. Second memory core interface 34 is coupled to second memory core 32 and allows a device connected to second memory card 21 to store (record) and retrieve (playback) data content in second memory core 32. That is, second memory core interface 34 stores/writes in, retrieves/reads out, or even erases data content in second memory core 32. Thus, during playback of data content, the data content from second memory core 32 is sent to second memory core interface 34. Storage capacity for second memory core 32 can also be, e.g., 64 Mbyte, 128 Mbyte, 256 Mbyte, etc.

Second memory card 22 also includes a second interface controller 35 and a second serial number holding circuit 33. Second interface controller 35 is coupled to second I/O terminals 26 and controls and processes signals to and from second I/O terminals 26. Second interface controller 35 is also coupled to second memory core interface 34. Second interface controller 35 includes control circuitry such as a central processing unit (CPU) to control and process signals.

Second serial number holding circuit 33 performs security functions for second memory card 22, and is controlled by second interface controller 35. In one example, if a device connected to second memory card 22 requests playback of data content in second memory core 32, the device sends a code key (e.g., serial number) to second interface controller 35. Second interface controller 35 will confirm the serial number with a serial number for second memory card 22 in the second serial number holding circuit 33. If the serial number is confirmed, the second interface controller 35 will allow the connected device to playback data content in second memory core 32 in second memory card 22.

In order for the connected device to store or record data content in second memory card 22, the second serial number holding circuit 33 sends the connected device a code key or serial number unique to second memory card 22 by way of second interface controller 35 and second I/O terminals 26. After receiving the serial number, the connected device outputs data to second memory card 22 in a coded format that corresponds to the serial number of second memory card 22. Second memory card 22 can then record the coded data in second memory core 32. In this manner, while maintaining data security, data content from the connected device can be stored in second memory card 22.

First and second memory cards 21 and 22 can communicate with each other via first and second connector terminals 25 and 27 using connector wiring 36 in connector 23. In the example shown in FIG. 3, each terminal in first and second connector terminals 25 and 27 are connected by a corresponding connector wiring. This allows data content to be exchanged between the first and second memory cards 21 and 22. For example, data content received by second memory card 22 via second I/O terminals 26 can be transferred to first memory card 21 via first and second connector terminals 25 and 27 and connector 23.

More particularly, first connector terminals 25 are coupled with first memory core interface 30. Data content in first memory core 38 can pass through first memory core interface 30 and first connector terminals 25 to second connector terminals 27 in the second memory card 22. Likewise, second connector terminals 27 are coupled with second memory core interface 34, and data content in second memory core 32 can pass through to second memory core interface 34 and second connector terminals 27 to first connector terminals 25 in first memory card 21. In this manner, data content between the first and second memory cores 28 and 32 of the first and second memory cards 21 and 22 can be shared.

Additionally, the data content transfer between memory cores 28 and 32 can take place without a code key or serial number verification process. Nevertheless, a code key or serial number verification process can take place in a manner described above between memory cards 21 and 22 to share data content.

Cutaways 37 and 38 are provided at lower ends of first and second memory cards 21 and 22, respectively. In particular, cutaway 37 is located at a lower end of one side of first memory card 21 that is at the same side as first I/O terminals 24. Cutaway 38 is located at a lower end of one side of second memory card 22 that is at the same side as second I/O terminals 26. Cutaways 37 and 38 allow a user to connect correctly applicable devices to memory cards 21 and 22 and to distinguish the connector terminal ends (25 and 27) from I/O terminals ends (24 and 26). That is, cutaways 37 and 38 are provided so that memory cards 21 and 22 can be connected at correct I/O terminal positions to applicable devices. In the example of FIG. 3, because the first and second memory cards 21 and 22 are connected by way of connector 23, cutaways 37 and 38 are located such that wiring 36 within connector 23 do not intersect.

Furthermore, to implement security functions for the first and second memory cards 21 and 22, first and second memory cores 28 and 32 may include a data protection area and a user data area. The data protection area can store code keys and other secured data. This area for both first and second memory cores 28 and 32 can be configured to be accessible in a secured and controlled manner. For instance, these memory cores can be configured to allow a system access to the data protection area after a mutual verification process using specific code keys. The user data area can store normal, accessible user data.

One example of using both the data protection area and the user data area for downloading/recording data content into first and second memory cards 21 and 22 is as follows. If music data content is downloaded into either first memory card 21 or second memory card 22, the data content can be recorded in the user data area of its memory core after it has been coded (encrypted) with a code key and other control information stored in the data protection area of its respective memory core, which is only accessible based on a verification process. Thus, the information stored in the data protection area can be copied only by a legitimate and mutually verifiable process. In addition, to playback or retrieve data content from a respective memory core, the code key used to code the data content can be retrieved from the data protection area, and the retrieved code cay be used decode the coded content by a device connected to either first memory card 21 or second memory card 22.

Referring to FIG. 4, the perspective view of memory card 20 is shown without first and second interface controllers 29 and 35, first and second memory cores 28 and 32, and first and second memory core interfaces 30 and 34. First memory card 21 and second memory card 22 are connected by connector 23 on one side to form a single memory card 20. In FIG. 4, first and second connector terminals 25 and 27, as well as connector wiring 36, in connector 23, are shown for purposes of explanation. That is, such terminals and connector may be covered by connector 23 and not viewable externally. First and second I/O terminals 24 and 26 are shown on sides of first and second memory cards 21 and 22, while first and second cutaways 37 and 38 are shown in the foreground of the same sides, respectively. The sides of first and second memory cards 21 and 22 having first and second connector terminals 25 and 27 are inserted inside connector 23.

An exemplary process of recording data content of memory card 20 of FIGS. 3 and 4 will now be explained. Initially, first and second memory cards 21 and 22 are connected using connector 23 to form memory card 20. First data is then stored or recorded in first memory core 28 in first memory card 21 by way of first I/O terminals 24 of first memory card 21. An applicable device is connected to the first memory card 21 via first I/O terminals 24 and the first data is readout of first memory core 28 in first memory card 21 by the device.

During a period in which the first data is being read out of first memory card 21, second memory card 22 is detached from connector 23. An applicable device is then connected to second memory card 22 and second data is stored or recorded in second memory core 32 in second memory card 22 by way of second I/O terminals 26 of second memory card 22. Second memory card 22 with the second data is connected back to first memory card 21 by way of connector 23. Next, the second data recorded in second memory core 32 of second memory card 22 is then stored or recorded in first memory core 28 within first memory card 21 by way of connector 23. This process can be reversed such that first memory card 21 can be removed to record data content that can be transferred to second memory card 22.

Thus, by using a memory card structure such as memory card 20 described above, first I/O terminals 24 of first memory card 21 are connected to an applicable device and, while the data content in first memory card 21 is being enjoyed, second memory card 22 can be detached from connector 23 and connected to a different applicable device that can store different data content in the second memory card 22. In this manner, second memory card 22, detached from connector 23, can be carried a great distance and be actively used to store and record different data content.

The detached second memory card 22 can be reconnected to first memory card 21 and data content be transferred between the two memory cards. In particular, data content can be transferred from second memory core 32 in second memory card 22 to first memory core 28 in first memory card 21 by moving the data content through second interface controller 34, second connector terminals 27, connector 23, connector wiring 36, first connector terminals 25, and first memory core interface 30. For this series of actions, first I/O terminals 24 and first interface controller 29 can operate independently of each other. For instance, data content can be recorded in first memory core 28 in first memory card 21 from second memory card 22 and read out to an applicable device through first I/O terminals 24.

Furthermore, in the example of FIGS. 3 and 4, first memory core 28 in first memory card 21 is configured as a large capacity memory core for ordinary data content use. Second memory core 32 in second memory card 22 is configured as a small capacity sub-memory core for special data content use. Nevertheless, memory cores 28 and 32 can be configured with the same memory capacity for the same or different data content use. Unlike the example of FIG. 2, first and second memory cards 21 and 22 are physically separated from each other even if the first and second I/O terminals 24 and 26 are simultaneously connected to separate applicable devices. As such, since voltage does not act in a reciprocal manner, a difference in potential does not occur between the first and second I/O terminals 24 and 26. In this case, a signal-voltage conversion circuit is not required.

Furthermore, both memory cards 21 and 22 can be associated with the same serial number. In this manner, first and second serial number holding circuits 31 and 33 store and process the same serial number or code key so that data content cannot flow reciprocally to other memory cards whereby data content security is maintained having different serial numbers. This allows a user to enjoy data content recorded in the first memory card 21 using an applicable device connected to first I/O terminals 24, while other data content is introduced into second memory card 22 from a different applicable device connected to second I/O terminals 26. The other data content from the second memory card 22 can be introduced to first memory card 21.

First and second memory cards 21 and 22, like SD memory card 1 of FIG. 2, can be super-small, lightweight, highly durable, and include simple interfaces providing high-data transmission. These cards can also implement broad applications and functions and provide data content copyright protection. By using such memory cards, multiple devices, such as cable television, silicon audio devices, etc., can be accessed. Furthermore, a data exchanger is not required to copy data content between two memory cards.

Furthermore, the memory cards disclosed herein can be implemented with any number of different configurations. For example, the memory cards can be a multimedia card having the security functions implemented within the data content memory core instead of using a serial number holding circuit. Any number of modifications can be implemented for the disclosed memory card capable of connecting to multiple devices in the manner described herein.

The data content for recording or playing back can include any type of data content such as motion picture content, video content, etc. The memory cards disclosed herein can be used in place of media such as paper media, video cassettes, DVDs, etc. In particular, data content provided by newspapers, magazines, comic books, films, game software, etc. can be recorded in such memory cards. The memory card can also record downloaded data content such as music data recoded on CDs and digital books recorded on DVD-ROMs and MDs. The memory cards disclosed herein can be connected to devices, such as personal computers, portable digital assistants (PDAs), high-performance cellular telephones, terminals that can be installed in convenience stores, etc., to download data content from these devices and stored in the memory cards.

Data content provides can distribute data content to the memory cards using any number communications means including telephone lines, communication satellites, high-speed data cable, etc. The devices that can be used to play back information are, for example, digital audio signal playback devices that use freely removable memory cards, and together with amplifiers, speakers, CD players, MD players, tuners, etc., these can constitute audio systems.

Thus, a memory card and memory card data recording method have been described. It should be understood, however, that the detailed description and specific examples, while indicating preferred embodiments of the invention, are given by way of illustration only, since various changes and modifications within the spirit and scope of the invention will become apparent to those skilled in the art from this detailed description. Therefore, the scope of the invention is defined by the appended claims.

What is claimed is:

1. A memory card comprising:
first input/output (I/O) terminals having at least one terminal for inputting and outputting first data;
a first interface controller to control the first data to and from the first I/O terminals;
second input/output (I/O) terminals having at least one terminal for inputting and outputting second data, and wherein the first data is different from the second data;
a second interface controller to control the second data to and from the second I/O terminals;
at least one memory core; and
a memory core interface controller to control retrieving or storing of at least one of the first data and second data in the memory core.

2. The memory card of claim 1, further comprising:
a serial number holding circuit to store and process at least one code key in order to provide memory card security with a device connected to at least one of the first and second I/O terminals.

3. The memory card of claim 1, further comprising:
a signal-voltage conversion circuit to adjust a voltage level at the second interface controller to be a same voltage level at the first interface controller.

4. The memory card of claim 1, wherein the first interface controller and the second interface controller operate independently of each other.

5. The memory card of claim 1, wherein the first and second I/O terminals are located at opposite ends of the memory card.

6. The memory card of claim 5, further comprising:
a first cutaway to identify the end of the memory card having the first I/O terminals; and
a second cutaway to identify the end of the memory card having the second I/O terminals.

7. The memory card of claim 1, wherein the first and second I/O terminals can concurrently input and output the first data and the second data.

8. The memory card of claim 1, wherein the first and second I/O terminals are connectable to at least an external device.

9. The memory card of claim 8, wherein the external device includes a playback device or a download device.

10. The memory card of claim 1, wherein the first and second data include music data, video data, multi-media data, text data, game software data, and other like data.

11. A data recording method for a memory card comprising:
recording first data in a memory core of the memory card via first input/output (I/O) terminals; and
recording second data in the memory core of the memory card via second input/output (I/O) terminals, wherein the first I/O terminals and second I/O terminals are respectively located at opposite ends of the memory card.

12. The data recording method of claim 11, further comprising:
reading the first data from the memory core in the memory card by a first external device via the first I/O terminals.

13. The data recording method of claim 12, wherein the second data is recorded in the memory core of the memory card from a second external device via the second I/O terminals.

14. The data recording method of claim 13, wherein the first and second external devices include a playback device or a download device.

15. The data recording method of claim 11, wherein the first and second data include music data, video data, multi-media data, text data, game software data, and other like data.

16. A memory card comprising:
first input/output (I/O) terminals having at least one terminal for inputting and outputting first data;
a first interface controller to control the first data to and from the first I/O terminals;
first connector terminals capable of connecting the memory card to a different memory card;
at least one memory core; and
a memory core interface controller to control retrieving or storing of at least the first data in the memory core.

17. The memory card of claim 16, wherein the first connector terminals are capable of connecting the memory card to the different memory card via a connector that connects second connector terminals of the different memory card to the first connector terminals of the memory card.

18. The memory card of claim 17, wherein the memory core interface controller controls retrieving or storing of second data from the different memory card.

19. The memory card of claim 16, further comprising:
a serial number holding circuit to store and process at least one code key in order to provide memory card security with a device connected to at least the first I/O terminals.

20. The memory card of claim 19, further comprising:
a first cutaway to identify an end of the memory card having the first I/O terminals.

21. A memory card comprising:
first and second memory cards, each card having at least one memory core to store data content and capable of connecting to separate devices and to each other; and
a connector capable of connecting the first memory card with the second memory card such that data content is capable of being transferred directly between the first and second memory cards.

22. The memory card of claim 21, wherein the first memory card comprises:
first input/output (I/O) terminals having at least one terminal for inputting and outputting first data;
a first interface controller to control the first data to and from the first I/O terminals;
first connector terminals to connect the first memory card to the connector; and
a first memory core interface controller to control retrieving or storing of at least one of the first data in the memory core of the first memory card.

23. The memory card of claim 22, wherein the second memory card comprises:
second input/output (I/O) terminals having at least one terminal for inputting and outputting second data;
a second interface controller to control the second data to and from the first I/O terminals;
second connector terminals to connect the second memory card to the connector; and
a second memory core interface controller to control retrieving or storing of at least one of the second in the memory core of the second memory card.

24. The memory card of claim 23, wherein the first and second data in the first and second memory card, respectively, are capable of being transferred between the first and second memory cards via the connector and the first and second connector terminals.

25. The memory card of claim 23, wherein the first memory card further comprises a first serial number holding circuit to store and process at least one code key in order to provide memory card security with a device connected to the first I/O terminals of the first memory card.

26. The memory card of claim 23, wherein the second memory card further comprises a second serial number holding circuit to store and process at least one code key in order to provide memory card security with a device connected to the second I/O terminals of the second memory card.

27. The memory card of claim 25, wherein the code key of the first and second serial number holding circuits is identical.

28. The memory card of claim 23, wherein the first and second I/O terminals are located at opposite ends of the memory card.

29. The memory card of claim 28, further comprising:
first and second cutaways identifying the first and second I/O terminals.

30. The memory card of claim 21, wherein the first and second memory cards are independently separable.

31. The memory card of claim 21, wherein the first and second memory cards are capable of connecting at least one of a playback device and a download device.

32. The memory card of claim 1, wherein the data content in the memory cards include music data, video data, multi-media data, text data, game software data, and other like data.

33. A method of recording data into a memory card having a first memory card and a second memory card interconnected by a connector, the method comprising:
recording first data into the first memory card;
reading the first data from the first memory card by a first device;
detaching the second memory card from the connector;
recording second data into the second memory card from a second device;
reattaching the second memory card to the connector; and
copying the second data from the second memory card into the first memory card.

34. The method of claim 33, wherein the second memory card is detached while the first data is being read by the first device.

35. The method of claim 33, wherein recording the second data is recorded by the second memory card while the first data is being read by the first device.

36. The method of claim 33, wherein the first and second devices include at least one of a playback device and a download device.

37. The method of claim 33, wherein the first data and the second include music data, video data, multi-media data, text data, game software data, and other like data.
